(19) United States
(12) Patent Application Publication
(10) Pub. No.: US 2018/0124062 A1
(43) Pub. Date: May 3, 2018

(54) System And Method For Controlling Access Of Users To Sensitive Information Content In An Organization

(71) Applicant: e-Safe Systems Sdn Bhd, Kuala Lumpur (MY)

(72) Inventors: Simon David Scott, Kuala Lumpur (MY); Rizwan Mahmood, Kuala Lumpur (MY); Akhil Subedi, Kuala Lumpur (MY); Ian McKinley, Kuala Lumpur (MY); Seyed Ali Firozebarqad, Kuala Lumpur (MY)

(73) Assignee: e-Safe Systems Sdn Bhd, Kuala Lumpur (MY)

(21) Appl. No.: 15/366,780

(22) Filed: Dec. 1, 2016

(30) Foreign Application Priority Data
Nov. 3, 2016 (MY) PI 2016704050

(51) Int. Cl. H04L 29/06

(52) U.S. Cl. CPC H04L 63/104; H04L 63/105

(57) ABSTRACT

An enterprise security system for controlling access of users to sensitive information content in an organization is provided herein. The system includes a processor and a memory. The system includes a classify module configured to classify sensitive information content into types of sensitive information content. The enterprise security system further includes a rules module configured to construct rules for mapping each user's request for each type of sensitive information content into one of three outcomes, the outcomes include ‘allow’, ‘block’, and ‘allow if reason’. The system further includes a map module configured to receive a user's request for a type of sensitive information content, and map the user's request into one of the three outcomes, based on the rules constructed. The system further includes an access module configured to allow access to the user to the type of sensitive information content, based on the one of the three outcomes.

### CROSS-REFERENCE TO RELATED APPLICATION

This application claims priority to Malaysian Patent Application No. PI 2016704050, filed on Nov. 3, 2016, the complete disclosure of which, in its entirety, is herein incorporated by reference.

### FIELD OF THE INVENTION

Embodiments of the present invention, generally relate to enterprise security systems including data leakage prevention (DLP), encryption and rights management (RMS), and in particular relate to an enterprise security system and method for controlling access of users to sensitive information content in an organization.

### BACKGROUND

Information within organizations and entities is often classified as sensitive information either for business reasons or for legal reasons or for some other reasons. This information may reside within databases, text files, messages, images, etc. A potential threat to this sensitive information is always there from an unscrupulous party illegally accessing the organization from the outside via an electronic network or even from the inside, and then removing or disrupting the information or sending the information outside.

Technology companies have reacted to this environment with a host of data leakage prevention (DLP) products and encryption and rights management (RMS). These products are typically hardware/software platforms that monitor and prevent sensitive information from being leaked outside the company, and automatically enforce data protection policies.

However, these conventional security systems fail to address ‘insider threat’ in an effective manner. Insider threat is where users who are authorised to access and export information from a computer system abuse their privilege and steal, leak or use the information for their own purposes. For example, a disgruntled employee may send sensitive information to which he or she has access to an outside party via e-mail or take print and circulate outside, thus causing harm to the organization.

Conventional security systems only provide options to ‘allow’ or ‘block’ access to sensitive data (as shown in FIG. 7) and its subsequent usage, such as print the information or copy/pasting out of an application. Most of the conventional security systems employ static rules to govern the access/usage of the different types of information by different users in different circumstances. In order for conventional security systems to work perfectly, these rules need to perfect at all times. However, business needs are always changing and users are sometimes required to access or use information they would not normally be allowed to in order to do their job.

Some of the conventional security systems employ the machine learning techniques (for example, artificial intelligence) to govern the access of the different types of information to different users. However, these conventional systems also provide limited options (i.e., ‘allow’ or ‘block’) for accessing the sensitive data, and hence fail to effectively address changing needs of the business as well as users in different circumstances.

Where users are blocked from accessing information, they need to request the staff responsible for maintaining the security system to amend the rule. This requires a lot of effort on the part of the user and rule changes take time to implement.

Where users are allowed to access and/or use information, then the user actions are often monitored and reported, however those reviewing the access/usage reports (or logs) have no useful information for determining whether the access and/or usage was for a legitimate purpose. As such, conventional security systems are unwieldy, ineffective and severely impede critical business processes.

Further, some of conventional systems invite the user to give a reason for accessing/using information but the reason is passed to the system administrator, and the system denies access until the system administrator explicit allows access, which causes a lot of delay and inconvenience to legitimate requests coming from the users in the changing business environment.

Therefore, there is a need for an improved system and a method for controlling access of users to sensitive information content in organizations.

### SUMMARY

According to an aspect of the present disclosure, an enterprise security system (102) for controlling access of users to sensitive information content in an organization is provided. The enterprise security system (102) comprising a processor and a memory. The enterprise security system (102) includes a classify module (202) configured to classify sensitive information content into types of sensitive information content. The enterprise security system (102) further includes a rules module (204) configured to construct rules for mapping each user's request for each type of sensitive information content into one of three outcomes, the outcomes comprises ‘allow’, ‘block’, and ‘allow if reason’. The enterprise security system (102) further includes a map module (206) configured to receive a user's request for a type of sensitive information content, and map the user's request into one of the three outcomes, based on the rules constructed. The enterprise security system (102) further includes an access module (208) configured to allow access to the user to the type of sensitive information content, based on the one of the three outcomes.

According to another aspect of the present disclosure, a computer-implemented method for controlling access of users to sensitive information content in an organization is provided. The computer-implemented method includes classifying sensitive information content into types of sensitive information content and constructing rules for mapping each user's request for each type of sensitive information content into one of three outcomes, the outcomes comprises ‘allow’, ‘block’, and ‘allow if reason’. The computer-implemented method further includes receiving a user's request for a type of sensitive information content and mapping the user's request into one of the three outcomes, based on the rules. The computer-implemented method further includes allowing access to the user to the type of sensitive information content, based on the one of the three outcomes.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 is a block diagram depicting a network environment according to an embodiment of the present invention;

FIG. 2 is a block diagram of modules stored in memory, according to an embodiment of the present invention;

FIG. 3 illustrates a schematic diagram of a screen shot of enterprise security system that can perform classification of information content by type, according to an embodiment of the present invention;

FIG. 4 illustrates a schematic diagram of a screenshot of enterprise security system that provides definition of rules, according to an embodiment of the present invention;

FIG. 5 illustrates a schematic diagram of a screenshot of enterprise security system that provides mapping of rules to different users, according to an embodiment of the present invention;

FIG. 6 illustrates a schematic diagram of a screen shot of enterprise security system that allows overriding of rules for default mapping of users, according to circumstances, according to an embodiment of the present invention;

FIG. 7 illustrates a schematic diagram of conventional security system providing ‘allow’ or ‘block’ access of information;

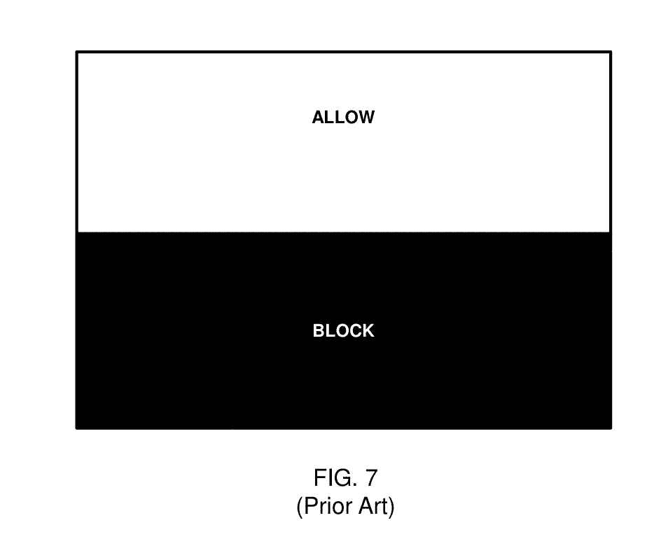

FIG. 8 illustrates a schematic diagram of enterprise security system that is able to provide a third option—‘allow if the user provides a reason for their action’, according to an embodiment of the present invention;

FIG. 9 illustrates a schematic diagram of a screen shot of enterprise security system that enables the user to enter a reason, according to an embodiment of the present invention; and

FIG. 10 depicts an exemplary flowchart illustrating a method for controlling access of users/employees to sensitive information content in an organization, according to an embodiment of the present invention.

To facilitate understanding, like reference numerals have been used, where possible, to designate like elements common to the figures.

### DETAILED DESCRIPTION

As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

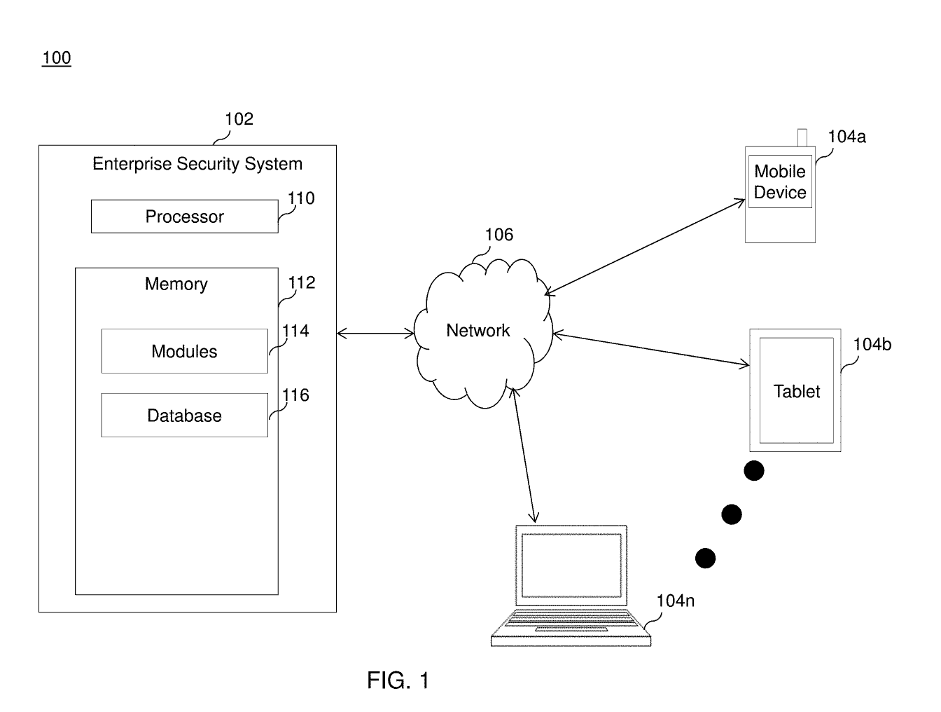

FIG. 1 illustrates an exemplary network environment (100) where various embodiments of the present invention may be implemented. In an embodiment, the network environment (100) belongs to an organization/entity/enterprise that requires protecting its sensitive information from outsider and insider attack. The network environment (100) includes an enterprise security system (102) connected to various electronic devices 104a (mobile), 104b (tablet) . . . 104n, (hereinafter referred as 104) via a network (106). The Network (106) may include, but is not restricted to, a communication network such as Internet, PSTN, Local Area Network (LAN), Wide Area Network (WAN), Metropolitan Area Network (MAN), and so forth. In an embodiment, the network (106) can be a data network such as the Internet. Further, the messages exchanged between the enterprise security system (102) and the mobile devices (104) can comprise any suitable message format and protocol capable of communicating the information necessary for the enterprise security system (102) to protect sensitive information of the organization. The mobile devices (104) may utilize the enterprise security system (102) to access all files, database, messages, and images including sensitive information as well as non-sensitive information.

In an embodiment of the present invention, enterprise security system (102) may be a computing device. In operation, a user of the mobile device (104) may access the enterprise security system (102) to access the sensitive information as well as non-sensitive information stored within databases, files, emails, messages and pictures of the organization. The enterprise security system (102) includes a processor (110) and a memory (112). In one embodiment, the processor (110) includes a single processor and resides at the enterprise security system (102). In another embodiment, the processor (110) may include multiple sub-processors and may reside at the enterprise security system as well as the mobile device.

Further, the memory (112) includes one or more instructions that may be executed by the processor (110) to determine mapping of the user's/employee's request for sensitive information content to one of three outcomes—‘allow’, allow if reason’ and ‘block’. In an embodiment, the enterprise security system (102) is configured to identify as well as classify all sensitive information of the organization into types of sensitive information.

Further, the enterprise security system (102) is configured to construct rules for determining mapping of various user's request for sensitive information into three outcomes depending upon role of user in the organization, nature of request (for example, to send the information to a non-company e-mail address), amount of information requested and user's previous history of requests. In one embodiment, the memory (112) includes the modules (114), a database (116), and other data (not shown in figure). The other data may include various data generated during processing of various requests for information access coming from the users. In one embodiment, the database (116) is stored internal to the enterprise security system (202). In another embodiment, the database (116) may be stored external to the enterprise security system (102), and may be accessed via the network (106). Furthermore, the memory (112) of the enterprise security system (102) is coupled to the processor (110).

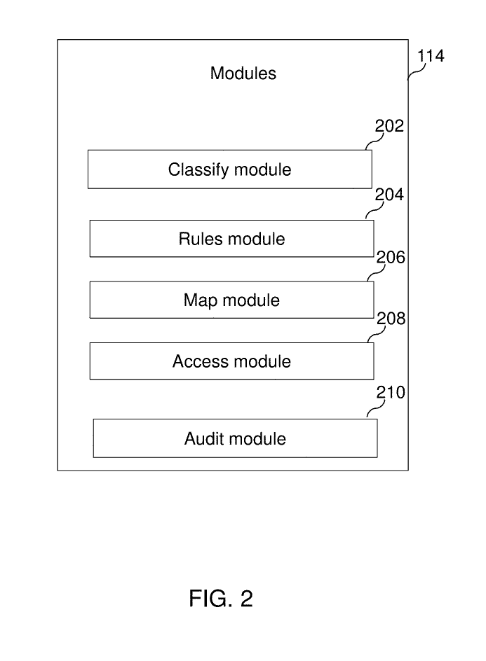

Referring to FIG. 2, the modules (114) includes a classify module (202), rules module (204), map module (206), access module (208), and audit module (210). The modules (114) are instructions stored in the memory and may provide for controlling access to secure/sensitive information content of an organization by users/employees.

According to an embodiment of the present invention, the classify module (202) is configured to first identify sensitive information content of the organization, and then classify the sensitive information content into types. For example, the information type ‘South Building Construction’ may contain all designs, budget spreadsheets, and progress reports relating to specific construction project, or ‘Customer Bank Account Details’ might include documents and database entries relating to customer bank accounts. The classify module (202) is configured to identify these types of information as sensitive information and, classify them into types of sensitive information including, but not limited to, sensitive business details, sensitive financial details, sensitive legal details, sensitive employee details etc. Further, sensitive information content, such as a document, may belong to multiple types.

The classify module (202) may use a plurality of methods to classify the sensitive information into types. In an embodiment, the classify module (202) may classify the sensitive information into types by defining rules that use existence of regular expressions or particular phrases within the information content. In another embodiment, the classify module (202) may allow an operator or an information owner to manually label the information content as belonging to a particular type. In yet another embodiment, the classify module (202) may utilize an artificial intelligence (AI) system to map information by type based on usage or existence of certain text within the information content.

Further, the classify module (202) is configured to assign an information owner to each type of the sensitive information. In an embodiment, the information owner may be a vertical head of the organization, for example, business head, legal head, operations head. In another embodiment, the information owner may be a manager or senior manager of the user/employee requesting sensitive information.

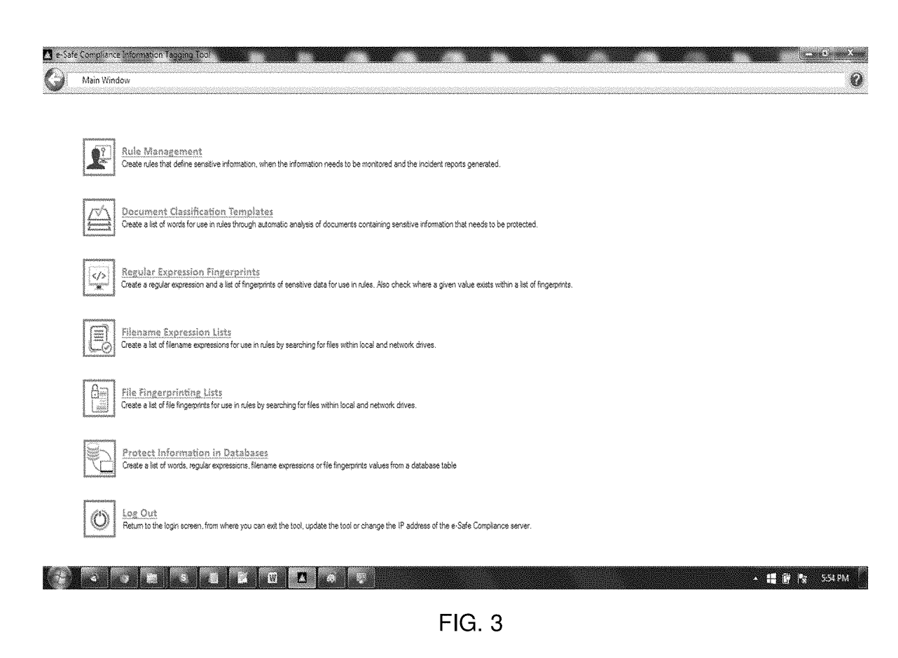

In an embodiment, the classify module (202) is configured to provide an ‘information tagging tool’, namely classification of information content by type using rules based on the text within the information content, as shown in FIG. 3. The information tagging tool, provided by the classify module (202), may search the databases, files, images, messages, emails, pictures of the organization and classify them into various types based on their content and rules.

According to an embodiment of the present invention, the rules module (204) is configured to construct rules for mapping users' requests for access/usage of a type of information and relevant circumstances to one of three outcomes—‘allow’, ‘allow if reason’ and ‘block’.

In an embodiment, the rules module (204) is configured to automatically consider changing business environment and changing needs of the users/employees according to changed circumstances. The rules module (204) may consider all details and relevant circumstances of the employee's/user's request before constructing rules of the mapping. Such details and circumstances include role of the user in the organisation, amount of information requested, the location of the request, the date/time of the request, the user's previous history of requests, and the nature of the request (for example to send the information to a non-company email address), etc.

In an embodiment, different rules may be constructed by the rules module (204) for request of same employee in different circumstances. For example, if the employee is requesting access to a sensitive information content type during regular business time of the organization, such request may be mapped to ‘allow if reason’. However, if same employee is requesting access to sensitive information content type during night/holidays/closing hours of business day of the organization, such request may be mapped to ‘block’.

Further, in another embodiment, different rules may be constructed by the rules module (204) for different users, according to their roles in the organization. For example, an associate level of employee may be blocked to access sensitive information content during night, but senior level of employee (senior manager) may be allowed to access the sensitive information content after providing reason, during night/holidays/outside the organization as it is possible that he may require it for some business development work. In case, the classify module (202) is using AI system, then the rules module (204) may utilize the rules learnt by the AI system.

Further, in another embodiment, different rules may be constructed by the rules module (204) for different users, having different history of requests. For example, an employee may be blocked to access sensitive information content, if he has made similar requests in past and misused the information or he has been blocked several times, but another employee, at same level, may be allowed to access the sensitive information content after providing reason, if he has good records of accessing and using the sensitive information content.

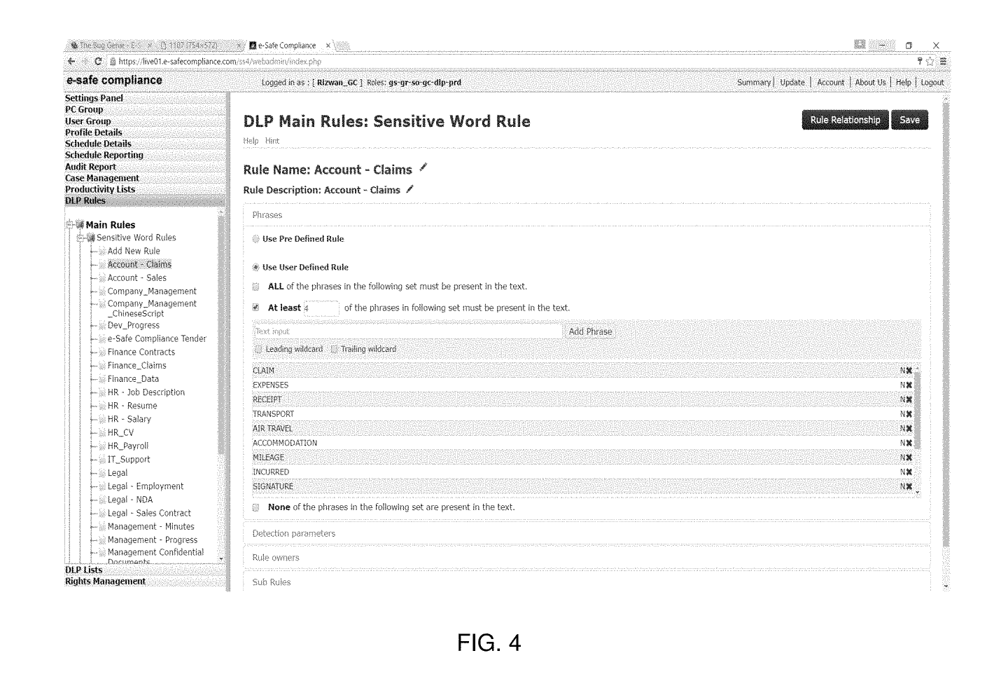

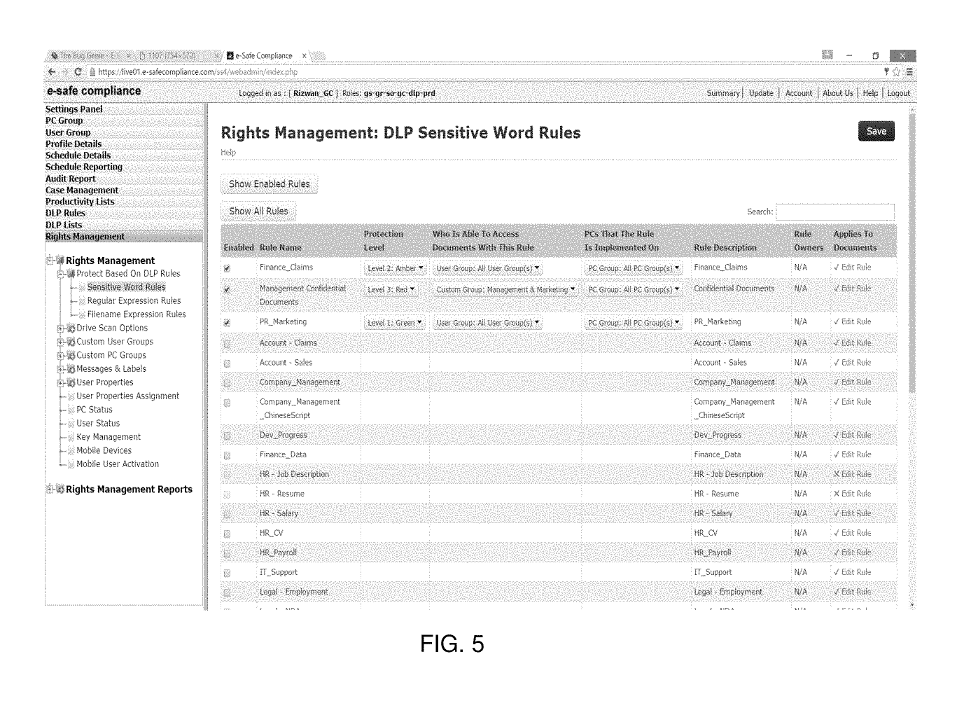

In an embodiment, the rules module (204) is configured to allow definition of rules by the operator/information owner, mapping of rules to the users, and mapping of users, information content and circumstances to an outcome, as shown in FIGS. 4, 5, & 6. In an embodiment, the rules module (204) enables heads of various departments or the central administration to define rules for accessing different types of information content to different users of the organization (as shown in FIG. 4). In an embodiment, various rules may be defined for various types of documents. For example, sales and accounts documents may be accessed by accounts team only. Further, payroll and resume documents can be access by HR team only. Similarly, various rules may be defined for finance, IT, legal and management documents as well.

Further, the rules module (204) may map the definition of rules to outcomes, i.e., who can access the document as ‘Allowed’ category and who can access the document under ‘Allowed with reason’ category (as shown in FIG. 5). In an embodiment, different rules can be set for junior staffs, middle management and top management. For example, management confidential documents can be accessed by a senior level of employee only, but a marketing document can be accessed by all.

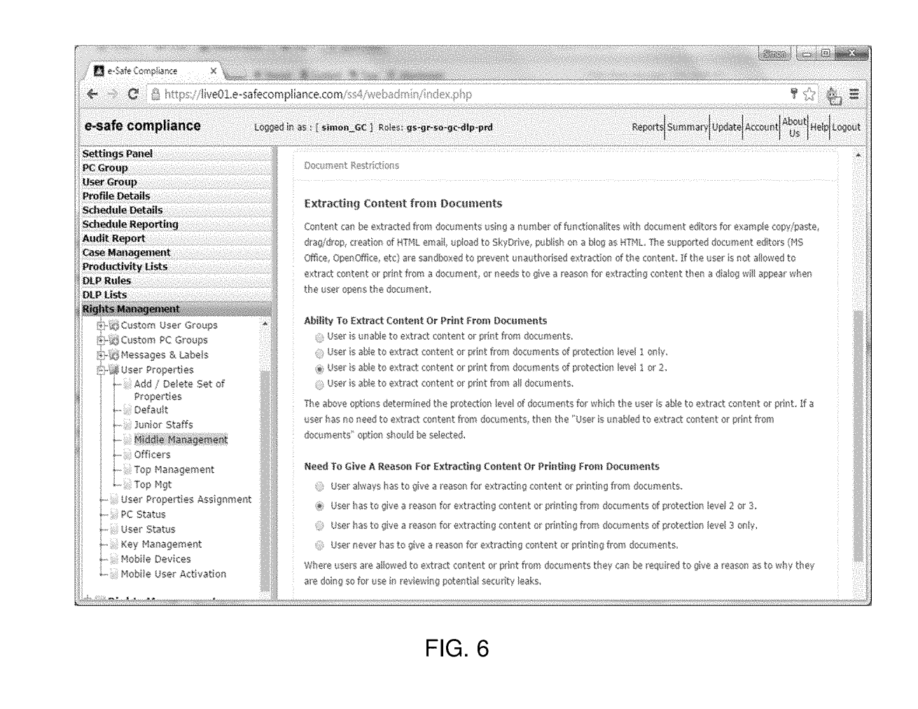

Further, the rules module (204) is configured to provide definition of usage profiles screen, wherein a default action (‘Allowed’ or ‘Allowed with reason’ or ‘Blocked’) for the users can be overridden depending upon circumstance, as shown in FIG. 6. In an embodiment, for same level of employee, different rules may exist according to different circumstances or different usages. For example, depending upon various current circumstances as explained above including time/day of request, nature of request, location of request, and amount of information, one employee may be allowed to access the sensitive information content, while another employee at same level may be allowed to access the sensitive information content after he provides the reason.

The map module (206) is configured to receive actual user requests for accessing the sensitive information content or specific usage of information content. In an embodiment, the request might be directly to the enterprise security system (102) itself, for example where the enterprise security system (102) takes the form of an application through which the user views and manipulates the information. For example, a document editor or an interface to a web-based system. In another embodiment, the request might be intercepted through an intermediary, such as a proxy server, a firewall, a file system driver, a library module or interface.

The map module (206) is configured to first check the classification type of the information requested by the user/employee. In an embodiment, unless the information content is directly labelled as being of a specific type, then the information classification rules are applied to calculate the information type or types for the content.

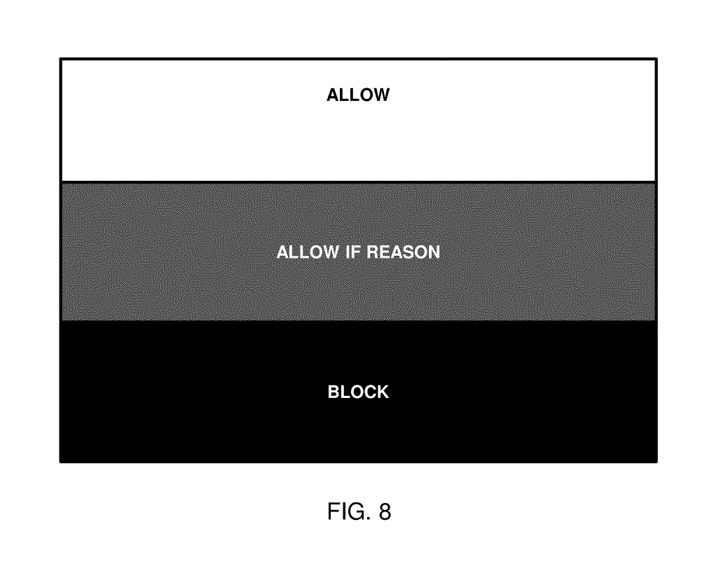

Further, the map module (206) is configured to map the user request for an information content type and the current circumstances to an outcome (‘allow’, ‘allow if reason’ or ‘block’) as shown in FIG. 8, based on the rules defined by the rules module (204).

The access module (208) is configured to directly allow the access to the requested information, if the outcome is ‘allow’. The access module (208) is configured to store the action and details of such employee/user, date/time, information accessed, etc into an access report.

If the outcome is ‘blocked’, the access module (208) is configured to send a notification to the employee/user that he is not allowed to access this information type. In an embodiment, the access module (208) may also display a reason why the employee is not allowed to access the information requested. In another embodiment, the access module (208) may not display any reason. The access module stores the action and details of such user, date/time, information accessed, etc. into the access report.

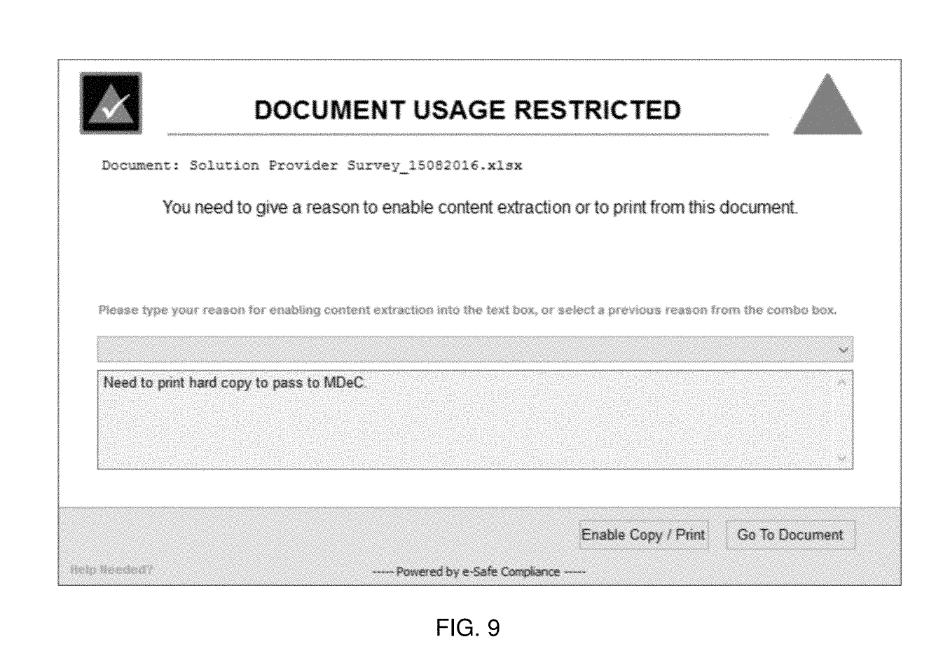

If the outcome is ‘allow if reason’, the access module (208) enquires the user about the reason for access and provides the employee/user with means to enter the reason for usage/access, as shown in FIG. 9. In an embodiment, the access module (208) may provide a text box, wherein the employee/user has to manually write the reason with help of a keyboard. In another embodiment, the access module (208) may provide a list of reason, and the employee/user may have to select the reason.

According to an embodiment of the present invention, the access module (208) is further configured to automatically validate the reason provided by the employee/user. In an embodiment, the reason supplied by the user is automatically validated by the access module (208) to make sure it does not consist of nonsensical characters. For example, the user may type anything, which may not be a valid reason to allow him access to the information requested. The access module (208) stores the action, reason and details such as user, date/time, information accessed, etc into the access report.

Further, according to an embodiment of the present invention, the access module (208) notifies the information owner about such request, but does not wait for a response from the information owner. Those skilled in the art will appreciate that this saves a lot of delay and inconvenience for the legitimate requests. The access module (208) directly allows access to the information, after the employee/user has provided a reason and the access module (208) has validated the reason.

Further, according to an embodiment of the present invention, the access module (208) is configured to send the access report periodically (once a day or once a week, or once a month) to the information owners. The information owners review the access/usage reports. Where there is possibility of misuse of the information by the user who accessed it, the information owner highlights the report. In an embodiment, in enterprise security system, where there are a large number of access reports, then analytic techniques may be used by the enterprise security system (102) to draw the attention of the information owner to various outliers within the reports.

Further, the access module (208) is configured to send the access report to the organisation's security/audit team. The security/audit team also reviews information access/usage reports. The audit module (210) is configured to receive and compare reviewed reports of the information owner and the security team for any discrepancies. In case of discrepancy, the audit module (210) is configured to notify and draw attention to the discrepancy. Those skilled in the art will appreciate that the purpose of the duplicated review of the reports by the security/audit team is to ensure that the information owner is performing their duties.

Security/audit team may also review information owner's own access and usage of information. Where there is possibility of misuse of the information by the information owner, the security/audit team may highlight the issue. The security/audit team may also review potential misuse of information as highlighted by the information owner and gathers further information from information owners and users involved. Security/audit team may provide the report to a security manager.

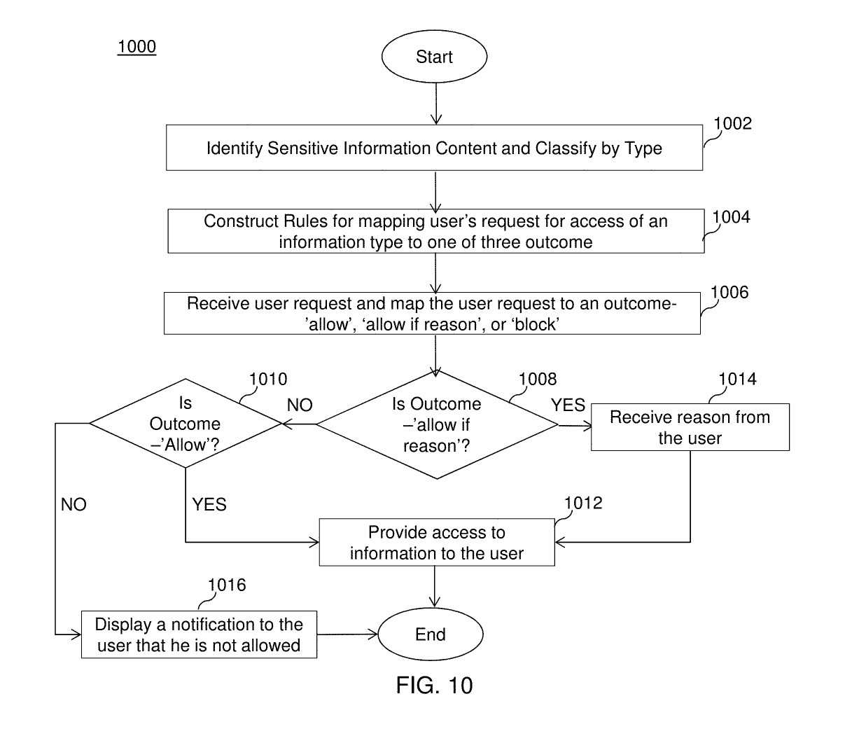

FIG. 10 illustrates an exemplary flowchart 1000 for a method of controlling access of users to sensitive information content in an organization, according to an embodiment of the present disclosure.

Initially, at step 1002, sensitive information content is identified and classified by type. It may be contemplated that according to an embodiment of the present disclosure, the information may be classified into types using existence of regular expressions or particular phrases within the information content. However, according to various alternative embodiments, any other method may also be used to classify the information into types. The types of sensitive information may include various types for example, sensitive business details, sensitive financial details, sensitive legal details, sensitive employee details etc.

At step 1004, rules are constructed for mapping each user's request for access to an information type to one of three outcomes—‘allow’, ‘block’, and ‘allow if reason’. In an embodiment, various circumstances during the request may also be considered for constructing the rules, for example, role of the user in the organisation, amount of information requested, the location of the request, the date/time of the request, the user's previous history of requests, and the nature of the request (for example to send the information to a non-company email address).

At step 1006, the user's request is received and mapped to an outcome of the three outcomes, based on the rules constructed. The outcomes include ‘allow’, ‘allow if reason’, or ‘block’.

At step 1008, it is determined if the outcome is ‘allow if reason’. If answer is ‘NO’, the method 1000 moves to step 1010. At step 1010, it is determined if the outcome is ‘allow’. If yes, the user is provided access to the information at the step 1012. Details of such employee/user, date/time, information accessed, etc may be stored into an access report. At step 1010, if the answer is ‘NO”, the user is displayed a notification that the user is not allowed to access this information type.

If the answer at the step 1008 is ‘YES’, the method 1000 moves to step 1014, wherein reason for access is received from the user. The reason is automatically validated and the user is provided access to the information at the step 1012. Details of such employee/user, date/time, information accessed, etc may be stored into the access report.

The enterprise security system (102) and the method 1000 performed by the enterprise security system (102) provide a third option as an effective police—that is ‘allow if the user provides a reason for their action’. This third option enables users to directly access and use a larger set of sensitive information than they would under the conventional ‘allow’/‘block’ approach, and so reduces the number of times the user is prevented from performing their job under changing business circumstances.

Further, the present disclosure provides separation of information access and usage into ‘allow’ and ‘allow if reason’, which allows managers to reduce the amount of time spent reviewing reports by having the reasons provided by the users in front of them particularly where access/usage of information approaches the limit of the user's job scope.

Further, the present disclosure provides a requirement for the user to enter a reason for accessing/using information, which reminds the user that their actions are being monitored. This perceived certainty of detection if they attempt to misuse information acts as an effective deterrent to the user from ever attempting to do so.

Furthermore, the present disclosure provides effective policing of both the ‘allow’ and ‘allow if reason’ is performed by i) providing the information owners with the report on who accessed the information, under what circumstances and the reasons provided; and ii) providing the same information to the security/audit team to ensure the information owners are reviewing reports correctly and that information owners themselves are not misusing information.

Further, the conventional systems merely invite the user to give a reason for accessing/using information, but the reason is passed to the system administrator, and the system denies access until the system administrator explicit allows access. However, the enterprise security system, disclosed here is different in that access/usage of information is immediately granted, it does not depend on the system getting a response from the system administrator. Further, the reason for the access/usage is sent to the information owner (rather than the system administrator) so that the legitimacy of the access/usage can be reviewed later.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An enterprise security system for controlling access of users to sensitive information content in an organization, the enterprise security system comprising a processor and a memory, the enterprise security system further comprising:
a classify module configured to classify sensitive information content into types of sensitive information content;
a rules module configured to construct rules for mapping each user's request for each type of sensitive information content into one of three outcomes, the outcomes comprises ‘allow’, ‘block’, and ‘allow if reason’;
a map module configured to receive a user's request for a type of sensitive information content, and map the user's request into one of the three outcomes, based on the rules constructed; and
an access module configured to allow access to the user to the type of sensitive information content, based on the one of the three outcomes.

2. The enterprise security system of claim 1, wherein the classify module is further configured to assign an information owner to each type of the sensitive information content.

3. The enterprise security system of claim 1, wherein the rules module is configured to construct rules for the mapping based on one or more of role of user in the organization, amount of information requested, location of request, date of request, time of request, nature of the request, and user's previous history of requests.

4. The enterprise security system of claim 1, wherein the access module is configured to allow access to the sensitive information type, if the outcome of the mapping of the user's request is ‘allow’.

5. The enterprise security system of claim 1, wherein the access module is configured to block the access to the sensitive information type, if the outcome of the mapping of the user's request is ‘block’.

6. The enterprise security system of claim 1, wherein the access module is configured to enquire the user a reason for access, if the outcome of the mapping of the user's request is ‘allow if reason’.

7. The enterprise security system of claim 6, wherein the access module is further configured to automatically validate the reason provided by the user.

8. The enterprise security system of claim 7, wherein the access module is further configured to store the reason and details of information accessed in an access report and notify an information owner for reviewing the access report.

9. The enterprise security system of claim 8, further comprising an audit module configured to compare the access report with the reviewed report of the information owner.

10. A computer-implemented method for controlling access of users to sensitive information content in an organization, the computer-implemented method comprising:
classifying sensitive information content into types of sensitive information content;
constructing rules for mapping each user's request for each type of sensitive information content into one of three outcomes, the outcomes comprises ‘allow’, ‘block’, and ‘allow if reason’;
receiving a user's request for a type of sensitive information content and map the user's request into one of the three outcomes, based on the rules; and
allowing access to the user to the type of sensitive information content, based on the one of the three outcomes.

11. The computer-implemented method of claim 10, wherein the classifying further comprises assigning an information owner to each type of the sensitive information content.

12. The computer-implemented method of claim 10, wherein the constructing rules comprises constructing rules for the mapping, based on one or more of role of user in the organization, amount of information requested, location of request, date and time of request, nature of the request, and user's previous history of requests.

13. The computer-implemented method of claim 10, wherein the allowing access comprises enquiring the user a reason for access, if the outcome of the mapping of the user's request is ‘allow if reason’.

14. The computer-implemented method of claim 13, further comprising automatically validating the reason provided by the user.

15. The computer-implemented method of claim 14, further comprising storing the reason and details of the information accessed in an access report and notifying an information owner for reviewing the access report.
